(19) United States
(12) Patent Application Publication
(10) Pub. No.: US 2004/0241370 A1
(43) Pub. Date: Dec. 2, 2004

(54) Adhesive composition and adhesive tape for mounting a mirror

(76) Inventors: Robert J. Cline, Milford, IN (US); Jonathan A. Shaffer, Kansas City, MO (US); Richard W. Paradise, Shawnee, KS (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/799,116

(22) Filed: Mar. 12, 2004

Related U.S. Application Data
(60) Provisional application No. 60/454,429, filed on Mar. 12, 2003.

(51) Int. Cl. B32B 9/00

(52) U.S. Cl. 428/40.1; 428/343; 428/64.1

(57) ABSTRACT

An adhesive tape including a layer of adhesive composition where the adhesive composition comprises an asphaltic material, at least one polymer, and a tackifying resin. The adhesive composition can further include a plasticizing agent and an absorptive filler. The adhesive tape can be used to mount any type of flat glass or mirror to a variety of substrates.

### CROSS-REFERENCE TO RELATED APPLICATION

This application claims the benefit of priority of U.S. Provisional Application No. 60/454,429, filed on Mar. 12, 2003, the disclosure of which is herein incorporated by reference in its entirety.

### BACKGROUND

Mirror installation typically involves: 1) applying a special adhesive (known in the industry as “mirror mastic”) to the back surface of a mirror, 2) pressing the mirror into place on a substantially flat surface until the mirror mastic adheres to the surface to at least temporarily support the mirror, 3) adjusting the mirror to the desired position, and 4) installing a mechanical support device along the bottom of the mirror to prevent the mirror from sagging until the mirror mastic cures and to permanently support the mirror. Optionally, the mechanical support device may be installed prior to the application of the mirror mastic to the backing of the mirror.

Mirror mastic can be characterized as a “special” adhesive because it is formulated to prevent damage to the reflective layer or coating on the back of plate glass mirrors. Also, some mirror mastics are specially formulated to prevent damage to the reflective layer or coating on the back of acrylic mirrors and/or to prevent damage to reinforcement safety backings on mirrors. Furthermore, mirror mastic maintains its flexibility even after it cures thereby permitting the mirror mastic to absorb normal vibrations or movements due to thermal changes that may otherwise cause a mirror to crack.

Mirror mastics are customarily available in the form of tubes/cartridges, cans, or drums. When mirror mastic is provided in a tube/cartridge, the mirror mastic is applied with a caulking gun or the like, which necessarily does not always dispense a repeatable amount of mirror mastic and is somewhat messy. In addition, the use of a caulking gun or the like to dispense mirror mastic requires some effort to apply the mirror mastic as well as time and effort to clean the caulking gun.

When mirror mastic is provided in a can or drum, the mirror mastic is applied using a stick or scoop. The use of a stick or scoop may result in uneven amounts of mirror mastic being applied to the back of the mirror and/or leftover mirror mastic in the can or drum that is wasted because it is difficult to remove with the stick or scoop or because it has cured prematurely. Also, using a stick or scoop is very messy requiring additional time and effort for clean up.

### BRIEF DESCRIPTION OF THE DRAWINGS

In the accompanying drawings and description that follow, like parts are indicated throughout the drawings and description with the same reference numerals, respectively. The figures are not drawn to scale and the proportions of certain parts have been exaggerated for convenience of illustration.

FIG. 1A is a perspective view of one embodiment of the adhesive composition in the form of a strip of adhesive tape 10;

FIG. 1B is a side view of the adhesive tape 10 having release paper 20 disposed on both surfaces;

FIG. 2A is a plan view of another embodiment of the adhesive composition in the form of circular adhesive patches of tape 200;

FIG. 2B is a side view of the adhesive patches of tape 200 having release paper 210 disposed on both surfaces;

FIG. 3 is an example methodology 300 associated with using an adhesive tape as a mirror mastic to mount a mirror to a substrate; and

FIG. 4 is another example methodology 400 associated with using an adhesive tape as a mirror mastic to mount a mirror to a substrate.

### DETAILED DESCRIPTION

The present invention is directed to an adhesive composition and method of using the adhesive composition as a mirror mastic. The adhesive composition can be used to mount any type of flat glass to various substrates. For example, the adhesive composition can be used to affix a glass mirror to various substrates such as metal, painted surfaces, wood, plasterboard, drywall, plaster, concrete, ceramic, porcelain, glass, mirror or mirror safety backing. It will be appreciated that the adhesive composition can also be used to mount acrylic and polycarbonate mirrors to a variety of substrates.

In one embodiment, the adhesive composition can take the form of a preformed, at least partially cured, adhesive tape having adhesive-like properties (e.g., tackiness) on some or all surfaces. For example, the adhesive tape can have sufficient surface tack to mount flat glass (e.g., mirror) to a variety of substrates. To be useful as a substitute or replacement for mirror mastic, the adhesive tape should be chemically compatible with mirror backing so that it will not damage the reflective layer or coating of the mirror. Additionally, the adhesive tape should not harden or turn brittle after it cures.

In one embodiment, the adhesive composition can include asphalt, at least one polymer to provide tackiness to the adhesive composition, and a tackifying resin for enhancing the tackiness of the composition. Optionally, the adhesive composition may further comprise a plasticizing agent and an absorptive filler.

The asphalt used in the adhesive composition may be selected from a variety of asphaltic materials. Specific non-limiting examples of suitable asphaltic materials include synthetically manufactured asphalt (which may be air-blown asphalt), blended asphalt, cracked or residual asphalt, petroleum asphalt, propane asphalt, straight-run asphalt, thermal asphalt, solvent-extracted asphalt, asphaltic pitches, or asphalt derived from natural sources. In one embodiment, the asphalt utilized has a ring and ball softening point between about 75-225° F. In one embodiment, the asphalt can have a ring and ball softening point between about 90-100° F. (commonly known as PG 58-22 or AC10).

In one embodiment, asphalt may be present in the adhesive composition in amounts ranging from about 40 weight percent (wt %) to about 70 wt % of the total composition. In another embodiment, asphalt may be present in the adhesive composition in amounts ranging from about 50 wt % to about 60 wt %.

As noted above, the adhesive composition can include one polymer or a combination of polymers to provide tackiness to the adhesive composition. The polymer(s) used in the adhesive composition may be selected from a variety of polymeric materials. Specific non-limiting examples of suitable polymeric materials include styrene-isoprene-styrene copolymer (SIS), styrene-butadiene-styrene copolymer (SBS), butyl rubber, recycled crumb rubber, styrene butadiene rubber (SBR), acrylate butadiene rubber (ABR), nitrile butadiene rubber (NBR), acrylonitrile butadiene styrene (ABS), methacrylate butadiene styrene (MBS), methylmethacrylate acrylonitrole butadiene styrene (MABS), styrene ethylene butylene styrene block copolymer (SEBS), ethylene propylene diene terpolymer (EPDM), APP, ethylene vinyl acetate (EVA), polyvinyl chloride (PVC) and the like.

In one embodiment, the polymer or combination of polymers may be present in the adhesive composition in amounts ranging from about 5 wt % to about 20 wt % of the total composition. In another embodiment, the polymer or combination of polymers may be present in the adhesive composition in amounts ranging from about 10 wt % to about 18 wt %.

As noted above, the adhesive composition can include a tackifying resin for enhancing the tackiness of the adhesive composition. The tackifying resin used in the adhesive composition may be selected from a variety of tackifying resins. Specific non-limiting examples of suitable tackifying resins include C-5 aliphatic hydrocarbon resin, aromatic hydrocarbons, coumarone-indene resins, synthetic terpene resins, low-molecular weight styrene resins, rosin hydrocarbon resins, alicyclic hydrocarbon resins and the like. In one embodiment, the tackifying resin can have a ring and ball softening point at about 100° C.

In one embodiment, the tackifying resin may be present in the adhesive composition in amounts ranging from about 10 wt % to about 25 wt % of the total composition. In another embodiment, the tackifying resin may be present in the adhesive composition in amounts ranging from about 15 wt % to about 20 wt%.

In another embodiment, the adhesive composition may further include a plasticizing agent to incorporate the at least one polymer into the asphalt. The plasticizing agent used in the adhesive composition may be selected from a variety of plasticizing agents. Specific non-limiting examples of suitable plasticizing agents include napthenic process oil, other hydrocarbon oils, phthalate, paraffinic and aromatic oils, long chain alkyl diesters, sebacic acid esters, glycol esters, fatty acid esters, phosphoric esters, stearic esters, epoxy plasticizers, polyether, polyester plasticizers, alkyl monoesters or long chain partial ether esters.

In one embodiment, the plasticizing agent may be present in the adhesive composition in amounts ranging from about 1 wt % to about 8 wt % of the total composition. In another embodiment, the plasticizing agent may be present in the adhesive composition in amounts ranging from about 2 wt % to about 6 wt %.

In yet another embodiment, the adhesive composition may further include an absorptive filler used to minimize migration of the plasticizing agent and add cohesive strength to the adhesive tape composition. The absorptive filler used in the adhesive composition may be selected from a variety of absorptive fillers. Specific non-limiting examples of suitable absorptive fillers include magnesium silicate, calcium carbonate, aluminum silicate, amorphous silicon dioxide and the like.

In one embodiment, the absorptive filler may be present in the adhesive composition in amounts ranging from about 5 wt % to about 20 wt % of the total composition. In another embodiment, the absorptive filler may be present in the adhesive composition in amounts ranging from about 10 wt % to about 15 wt %.

In one embodiment, the adhesive composition may comprise between about 40 wt % to about 70 wt % asphalt, between about 1 wt % to about 8 wt % napthenic process oil, between about 2 wt % to about 12 wt % styrene-isoprene-styrene copolymer, between about 2 wt % to about 12 wt % styrene-butadiene-styrene copolymer, between about 10 wt % to about 25 wt % C-5 aliphatic hydrocarbon resin, and between about 5 wt % to about 20 wt % magnesium silicate.

In the processing of the adhesive composition, the asphalt, polymer or combination of polymers, and tackifying agent along with the optional plasticizing agent and absorptive filler (collectively “the ingredients”) may be compounded using a heated mixing devices. Examples of heated mixing devices that can be used to process the adhesive composition include hot-oil jacketed paddle mixers, ribbon blenders, high-shear Silverson-type mixers, Seifer mills, Sigma-blade mixer, Banbury mixers, two-roll mills, and extruders. The temperature of the heated mixing device should be generally sufficient to cause the polymer or combination of polymers to flow so that the polymer or combination of polymers can form a matrix with the oils in the asphalt. In one embodiment, the ingredients can be admixed together at temperatures of at least 225° F. In another embodiment, the ingredients can be mixed together at temperatures ranging from between about 275° F. to about 325° F. However, other temperature ranges may be used depending on the specific polymer or combination of polymers included in the adhesive tape composition.

In one embodiment, the adhesive composition can be prepared by mixing the asphalt and the plasticizing agent in a heated mixing device, then adding in the tackifying resin until blended, adding in the polymer or combination of polymers until blended, and finally adding the filler until blended. However, it will be appreciated that the adhesive composition can be processed by adding the ingredients in any order.

In one embodiment, the adhesive composition can be extruded into a desired shape and size. For example, the adhesive composition can be extruded into a relatively thin, continuous strip using suitable extrusion equipment and allowed to at least partially cure thereby forming an adhesive tape.

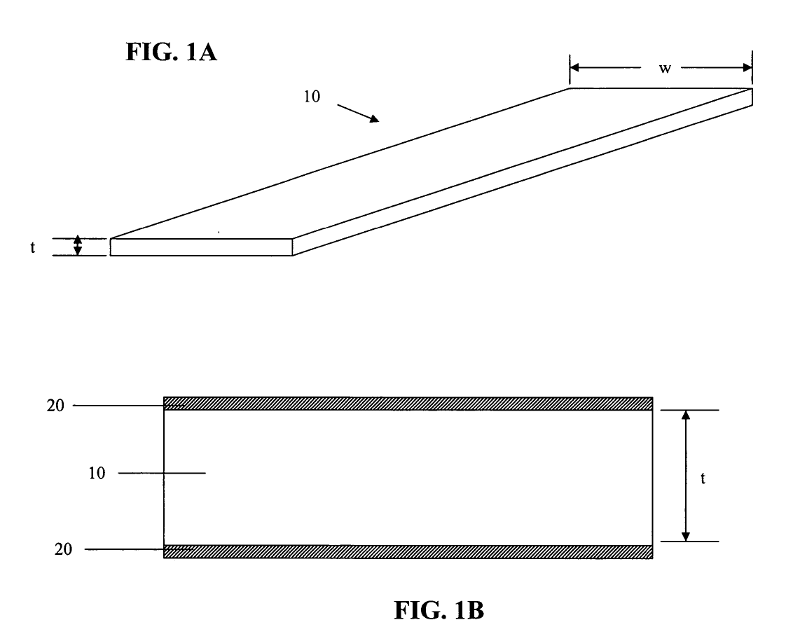

With reference to the drawings, FIG. 1A illustrates a perspective view of one embodiment of the adhesive composition in the form of a strip of adhesive tape 10 and FIG. 1B illustrates a side view of the adhesive tape 10 optionally sandwiched between release paper 20. The release paper 20 can prevent exposure of each surface of the strip of adhesive tape 10 to dust and the like prior to installation onto a mirror or substrate. Obviously, the release paper 20 may be disposed on only one major surface of the adhesive tape 10. However, it will be appreciated that the release paper 20 may not be provided on any surface of the adhesive tape 10.

In one embodiment, the adhesive tape 10 can be any desired thickness (t). For example, the thickness of the adhesive tape 10 can range from between about 0.05 inches to about 0.5 inches. However, it will be appreciated that the adhesive tape 10 can have a thickness outside this range.

In one embodiment, the adhesive tape 10 can be any desired width (w). For example, the width of the adhesive tape 10 can range from between about 0.25 inches to about 6 inches. However, it will be appreciated that the adhesive tape 10 can have a width outside this range.

In another embodiment, the adhesive tape 10 can be formed into a coil or roll where the user may cut the adhesive tape 10 to length. Alternatively, the adhesive tape 10 may be precut into pieces of desired length. For example, the adhesive tape 10 can be precut into three inch by three inch square patches.

In another embodiment, the adhesive composition can be dispensed onto release paper as a droplet and allowed to at least partially cure thereby forming a relatively thin patch of adhesive tape. For example, a dispenser having a circular nozzle can be used to dispense the adhesive composition onto release paper thereby forming a relatively thin circular patch of adhesive tape. Obviously, the relatively thin patch of adhesive tape can take the form of any desired shape and size.

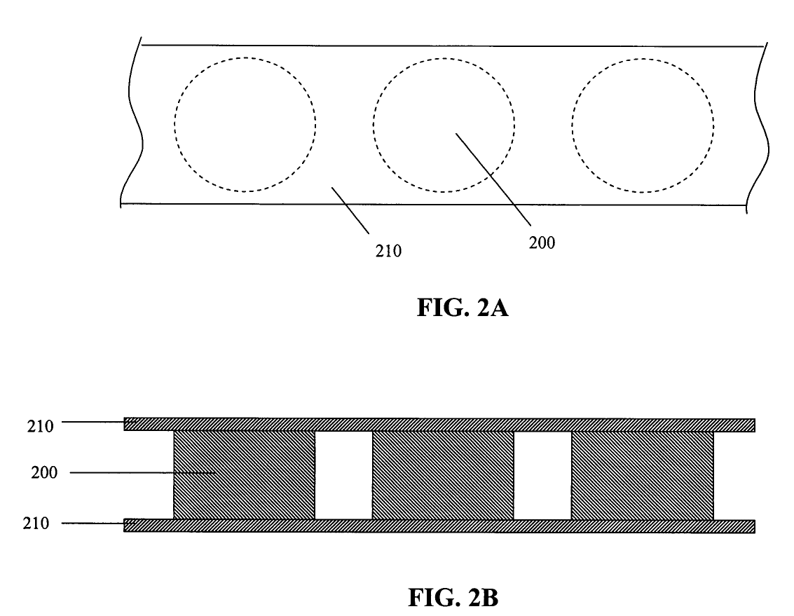

FIG. 2A illustrates a top view of one embodiment of the adhesive composition in the form of circular patches of tape 200 and FIG. 2B illustrates a side view of the circular patches of tape 200 optionally sandwiched between release paper 210. The release paper 210 can prevent exposure of each major surface of the circular patches of tape 200 to dust and the like prior to installation onto a mirror or substrate. Obviously, the release paper 210 may be disposed on only one major surface of the circular patches of tape 200. However, it will be appreciated that the release paper 210 may not be provided on any surface of the circular patches of tape 200.

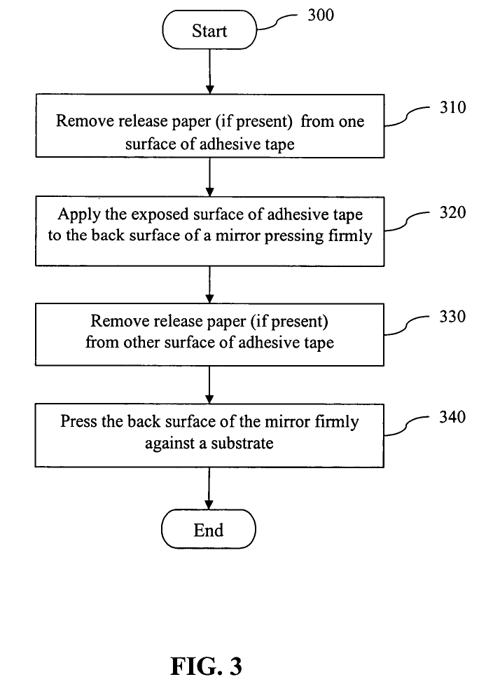

Illustrated in FIG. 3 is one embodiment of a methodology 300 associated with using an adhesive tape as described above as a substitute for mirror mastic. The illustrated elements denote “processing blocks” and represent functions and/or actions taken for registering print media. It will be appreciated the methodology may involve dynamic and flexible processes such that the illustrated blocks can be performed in other sequences different than the one shown and/or blocks may be combined or, separated into multiple components. The foregoing applies to all methodologies described herein.

With reference to FIG. 3, the methodology 300 includes removing release paper (if present) from one of the surfaces of the adhesive tape as shown (block 310). If only one surface of the adhesive tape has release paper disposed thereon or the adhesive tape lacks release paper disposed thereon, then the user need not remove the release paper at this time.

Once one surface of the adhesive tape is exposed, the user can then apply the exposed surface of the adhesive tape to the back surface of a mirror (or flat glass) and presses the adhesive tape firmly against the back surface of the mirror (block 320). The adhesive tape can be cut to length by the user or can be supplied by the manufacturer as precut patches or strips of adhesive tape. In one embodiment, a three inch circular adhesive patch can be applied to every square foot of mirror.

If present, the user can then remove the release paper from the other surface of the adhesive tape (or patch), which exposes the other surface of the adhesive tape (block 330). Once the other surface of the adhesive tape is exposed, the user can press the mirror against a substrate until the mirror is at least temporarily held into place (block 340). Optionally, the user may install a mechanical support device (e.g., 3-channel, decorative mirror clips, or the like) to permanently support the mirror.

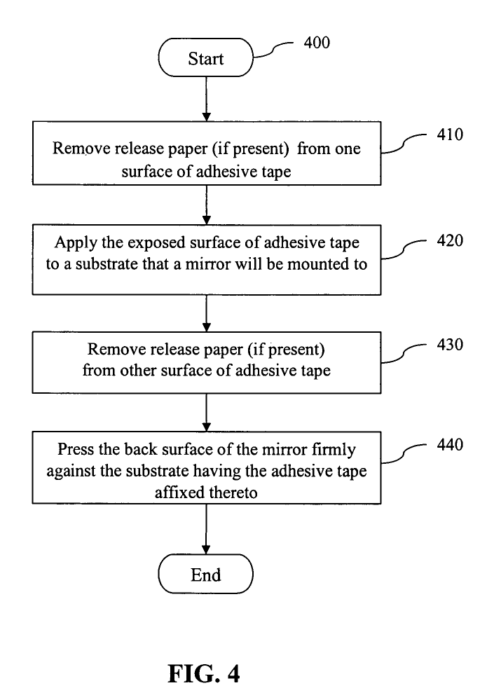

Illustrated in FIG. 4 is one embodiment of a methodology 400 associated with using an adhesive tape as described above as a substitute for mirror mastic. The methodology 400 includes removing release paper (if present) from one of the surfaces of the adhesive tape (block 410). If only one surface of the adhesive tape has release paper disposed thereon or the adhesive tape lacks release paper disposed thereon, then the user need not remove the release paper at this time.

Once one surface of the adhesive tape is exposed, the user can then apply the exposed surface of the adhesive tape to a substrate that a mirror (or flat glass) will be mounted to and presses the adhesive tape firmly against the substrate (block 420). The adhesive tape can be cut to length by the user or can be supplied by the manufacturer as precut patches or strips of adhesive tape. In one embodiment, a three inch circular adhesive patch can be applied to every square foot of mirror.

If present, the user can then remove the release paper from the other surface of the adhesive tape, which exposes the other surface of the adhesive tape (block 430). Once the other surface of the adhesive tape is exposed, the user can press the mirror against the substrate having the adhesive tape affixed thereon until the mirror is at least temporarily held into place (block 440). Optionally, the user may install a mechanical support device (e.g., J-channel, decorative mirror clips, or the like) to permanently support the mirror.

In another embodiment, the methodologies 300, 400 described above may further include the step of cleaning the mirror backing and substrate with a solvent to remove any traces of grease, oil or other contaminants which could interfere with adhesion of the mirror to the substrate.

In another embodiment, the methodologies 300, 400 described above may further include the step of sealing the substrate before adhering the mirror to the substrate. Example of substrates that should be sealed include unpainted plasterboard, concrete, or plaster. The sealer adds strength to the substrate and prevents caustic lime deposits that may damage the silver mirror backing.

In another embodiment, the methodologies 300, 400 described above may further include the step of stacking together multiple layers of the adhesive tape to provide thickness to bridge irregularities in the mirror backing or substrate.

The adhesive tape 10, 200 and the methodologies 300, 400 described herein can provide numerous advantages over conventional mirror mastics used in the industry. First, there is minimal or no waste since the user may cut the adhesive tape to length or the adhesive tape or patches are precut into manageable sizes and shapes. Second, special tools such as caulking guns, scoops, or sticks are not required to apply the adhesive tape or patches. Finally, there is little or no need for clean up required.

The invention is further described by the following non-limiting examples. The examples are merely illustrative and do not in any way limit the scope of the invention as described and claimed.

### EXAMPLE 1

650 pounds (lbs) of PG 58-22 asphalt and 53 lbs of napthenic oil were added to a hot-oil jacketed paddle mixer set at a temperature of 300° F. 200 lbs of C-5 hydrocarbon was then added and mixed with the other ingredients for about 15 minutes until blended. Next, 50 lbs of SBS was added and mixed with the other ingredients for about 30 minutes until blended. Then, 120 lbs of SIS was added and mixed with the other ingredients for about 30 minutes until blended. Finally, 150 lbs of magnesium silicate was added and mixed with the other ingredients for about 15 minutes until blended.

Once all the ingredients were mixed, the mixture (still in a somewhat viscous state) was poured onto 4 foot by 4 foot silicone-treated cardboard sheets. The material was cooled for at least 24 hours thereby forming the adhesive composition. After cooling, the adhesive composition was hand cut into 3 inch square pieces of tape using a heated utility knife, which were then placed on silicone-treated release paper. The thickness of the 3 inch square pieces of tape varied from between ⅛″ to ¼″.

A heat-aging test was conducted in which one inch square pieces of adhesive tape (cut from the 3 inch square pieces of tape from above) were affixed to the back of a mirror approximately three feet by three feet and weighing about 80 grams. The mirror was vertically hung in an oven heated to 120° F. for two weeks. The one inch square pieces of adhesive tape did not slump, deform or lose adhesion to the back surface of the mirror. Additionally, no leaching from the one inch square pieces of adhesive tape was observed.

### EXAMPLE 2

In a production setting, 2600 pounds (lbs) of PG 58-22 asphalt and 210 lbs of napthenic oil were added to a hot-oil jacketed paddle mixer set at a temperature of 300° F. 800 lbs of C-5 hydrocarbon resin was then added and mixed with the other ingredients for about 15 minutes until blended. Next, 198 lbs of SBS rubber was added and mixed with the other ingredients for about 30 minutes until blended. Then, 480 lbs of SIS rubber was added and mixed with the other ingredients for about 30 minutes until blended. Finally, 600 lbs of magnesium silicate was added and mixed with the other ingredients for about 15 minutes until blended.

Once all the ingredients were mixed, the mixture (still in a somewhat viscous state) was dispensed through a circular nozzle onto release paper thereby forming droplets of the mixture on the release paper. The droplets of mixture were allowed to at least partially cure and flatten out for at least 24 hours. The resultant adhesive composition was in the form of ⅛ inch thick and 3 inch diameter circular patches of tape.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

What is claimed is:

1. An adhesive tape including a layer of adhesive composition, the adhesive composition comprising:
an asphaltic material;
at least one polymer; and
a tackifying resin.

2. The adhesive tape of claim 1, wherein the adhesive composition further comprises a plasticizing agent.

3. The adhesive tape of claim 2, wherein the plasticizing agent is napthenic process oil.

4. The adhesive tape of claim 2, wherein the plasticizing agent is selected from the group consisting of napthenic process oils, hydrocarbon oils, phthalates, paraffinic oils, aromatic oils, long chain alkyl diesters, sebacic acid esters, glycol esters, fatty acid esters, phosphoric esters, stearic esters, epoxy plasticizers, polyether, polyester plasticizers, alkyl monoesters, long chain partial ether esters, and any combinations thereof.

5. The adhesive tape of claim 1, wherein the adhesive composition further comprises an absorptive filler.

6. The adhesive tape of claim 5, wherein the absorptive filler is magnesium silicate.

7. The adhesive tape of claim 5, wherein the absorptive filler is selected from the group consisting of magnesium silicate, calcium carbonate, aluminum silicate, amorphous silicon dioxide and any combinations thereof

8. The adhesive tape of claim 1, wherein the asphaltic material is selected from the group consisting of synthetically manufactured asphalt, air-blown asphalt, blended asphalt, cracked asphalt, residual asphalt, petroleum asphalt, propane asphalt, straight-run asphalt, thermal asphalt, solvent-extracted asphalt, asphaltic pitch and any combinations thereof.

9. The adhesive tape of claim 1, wherein one of the at least one polymer is styrene-isoprene-styrene copolymer.

10. The adhesive tape of claim 9, wherein one of the at least one polymer is styrene-butadiene-styrene copolymer.

11. The adhesive tape of claim 1, wherein the at least one polymer is selected from the group consisting of styrene-isoprene-styrene copolymer (SIS), styrene-butadiene-styrene copolymer (SBS), butyl rubber, recycled crumb rubber, styrene butadiene rubber (SBR), acrylate butadiene rubber (ABR), nitrile butadiene rubber (NBR), acrylonitrile butadiene styrene (ABS), methacrylate butadiene styrene (MBS), methylmethacrylate acrylonitrole butadiene styrene (MABS), styrene ethylene butylene styrene block copolymer (SEBS), ethylene propylene diene terpolymer (EPDM), APP, ethylene vinyl acetate (EVA), polyvinyl chloride (PVC) and any combinations thereof.

12. The adhesive tape of claim 1, wherein the tackifying resin is C-5 aliphatic hydrocarbon resin.

13. The adhesive tape of claim 1, wherein the tackifying resin is selected from the group consisting of C-5 aliphatic hydrocarbon resins, aromatic hydrocarbons, coumarone-indene resins, synthetic terpene resins, low-molecular weight styrene resins, rosin hydrocarbon resins, alicyclic hydrocarbon resins and any combinations thereof.

14. The adhesive tape of claim 1, covered on at least one side with release paper.

15. The adhesive tape of claim 1, covered on both sides with release paper.

16. The adhesive tape of claim 1, covered on one side with release paper and wound into a roll.

17. The adhesive tape of claim 1, formed into circular adhesive patches.

18. The adhesive tape of claim 1, formed into square adhesive patches.

19. An adhesive composition comprising:
asphalt;
a plasticizing agent;
at least one polymer;
a tackifying resin; and
an absorptive filler.

20. The adhesive composition of claim 19, wherein the asphalt comprises about 50 to about 60 wt % of the total composition.

21. The adhesive composition of claim 19, wherein the plasticizing agent comprises about 2 to about 6 wt % of the total composition.

22. The adhesive composition of claim 19, wherein the at least one polymer comprises about 10 to about 18 wt % of the total composition.

23. The adhesive composition of claim 19, wherein the tackifying resin comprises about 15 to about 20 wt % of the total composition.

24. The adhesive composition of claim 19, wherein the absorptive filler comprises about 10 to about 15 wt % of the total composition.

25. A method of mounting a mirror or flat glass to a substrate comprising the steps of:
applying an adhesive tape according to any one of claims 1-19 to a back surface of the mirror, and
pressing the back surface of the mirror against the substrate until the mirror adheres to the substrate.
